(19) United States
(12) Patent Application Publication
(10) Pub. No.: US 2004/0239115 A1
(43) Pub. Date: Dec. 2, 2004

(54) Mechanical pipe coupling derived from a standard fitting

(75) Inventors: Charles E. Wilk JR., Northampton, PA (US); Anthony J. Cuvo, Coopersburg, PA (US); Jianyong Sun, Macungie, PA (US); Douglas R. Dole, Whitehouse Station, NJ (US)

Correspondence Address: SYNNESTVEDT & LECHNER, LLP, 2600 ARAMARK TOWER, 1101 MARKET STREET, PHILADELPHIA, PA, 191072950

(73) Assignee: Victaulic Company of America, Easton, PA

(21) Appl. No.: 10/869,758

(22) Filed: Jun. 16, 2004

Related U.S. Application Data
(63) Continuation-in-part of application No. 10/123,607, filed on Apr. 16, 2002.
Application No. 10/123,607 is a continuation-in-part of application No. 10/007,951, filed on Dec. 3, 2001.
(60) Provisional application No. 60/262,820, filed on Jan. 19, 2001.

(51) Int. Cl. F16L 39/00

(52) U.S. Cl. 285/340; 285/319; 285/322

(57) ABSTRACT

A coupling for joining pipe segments together is disclosed. The coupling is derived from a standard fitting and has a housing with a socket and an expanded region adjacent to the socket. Three shoulders are positioned within the expanded region. A sealing member and two support washers are positioned within the expanded region, each engaging a shoulder. A retainer is positioned in the expanded region between the two support washers. A lip, positioned at the end of the expanded region, extends radially inwardly and captures the sealing member, washers and retainer within the coupling. The retainer has a plurality of radial teeth angularly oriented to engage a pipe and prevent its removal from the coupling. One of the washers is kept in spaced relation from the other washer by a shoulder to prevent contact with the retainer upon assembly which may otherwise inhibit the teeth engaging the pipe.

### RELATED APPLICATION

This application is a continuation-in-part of U.S. application Ser. No. 10/123,607, filed Apr. 16, 2002, which is a continuation-in-part of U.S. application Ser. No. 10/007,951, filed Dec. 3, 2001, which is based on and claims priority of U.S. Provisional Application No. 60/262,820, filed Jan. 19, 2001.

### FIELD OF THE INVENTION

This invention relates to couplings for pipes and especially to mechanical couplings derived from standard fittings which effect a strong, reliable joint with a fluid-tight seal without the need for brazing or soldering.

### BACKGROUND OF THE INVENTION

The construction of piping networks requires couplings that can form fluid-tight joints between pipe ends which can withstand external mechanical forces, as well as internal fluid pressure and reliably maintain the integrity of the joint. Many forms of joints are known, such as brazed or soldered joints, threaded joints, welded joints and joints effected by mechanical means.

For example, copper tubing, which is used extensively throughout the world to provide water service in homes, businesses and industry, is typically joined by means of couplings which are soldered to the pipe ends to effect a connection.

The use of copper tubing for piping networks is so widespread that standard tubing sizes have been established in various countries. For example, in the U.S., there is the ASTM Standard; in Germany, the DIN Standard; and in the United Kingdom, the British Standard (BS). Chart 1 below shows a portion of the range of nominal diameters of the various standard copper tubes listed above.

CHART 1
Standard Outer Copper Tube Outer Diameters

| ASTM | DIN | BS |
|---|---|---|
| ½″ | 15 mm | 15 mm |
| ¾″ | 22 mm | 22 mm |
| 1″ | 28 mm | 28 mm |
| 1.25″ | 35 mm | 35 mm |
| 1.5″ | 42 mm | 42 mm |
| 2″ | 54 mm | 54 mm |

Naturally, there are standard pipe fittings such as elbows (45° and 90°), tees and straight segments matched for use with the standard tube diameters. These standard fittings are defined in the U.S. by ASME Standard B16.22a-1998, Addenda to ASME B16.22-1995 entitled “Wrought Copper and Copper Alloy Solder Joint Pressure Fittings” dated 1998 and hereby incorporated by reference. The standard fittings have open ends with inner diameters sized to accept the outer diameter of a particular standard tube in mating contact for effecting a soldered joint.

In addition to the standard fittings described above, other components, such as valves, strainers, adapters, flow measurement devices and other components which may be found in a pipe network, will have a coupling which is compatible with the standard pipe, and it is understood that the term “coupling”, when used herein, is not limited to a standard elbow, tee or other fitting but includes the open end of any component useable in a piping network which serves to couple the component to the pipe end.

A soldered joint is effected between a standard diameter tube end and its associated standard fitting by first cleaning the surfaces to be joined, typically with an abrasive such as a wire brush or steel wool, to remove any contaminants and the oxide layer which forms on the surfaces. Next, the cleaned surfaces are coated with a flux material, usually an acid flux, which further disrupts the oxide layer (especially when heated) and permits metal to metal contact between the fitting, the pipe end and the solder. The pipe end is next mated with the fitting thereby bringing the cleaned, flux coated surfaces into contact. The fitting and pipe end are then heated to the melting temperature of the solder, and the solder is applied to the interface between the tube and the fitting. The solder melts, flows between the surfaces of the pipe end and the fitting via capillary action and upon cooling and solidifying forms the solder joint. Excess flux is removed from the outer surfaces to prevent further acid etching of the pipe near the joint.

While the soldered joint provides a strong, fluid-tight connection between pipe end and fitting, it has several disadvantages. Many steps are required to make the soldered joint, thus, it is a time consuming and labor intensive operation. Some skill is required to obtain a quality, fluid-tight joint. Furthermore, the solder often contains lead, and the flux, when heated, can give off noxious fumes, thus, exposing the worker to hazardous substances which can adversely affect health over time. The joint is typically heated with an open gas flame which can pose a fire hazard, as well as a personal burn hazard.

To overcome these disadvantages, many attempts have been made to create mechanical couplings which do not require solder or flame to effect a strong, fluid-tight joint. Such mechanical couplings often use an over-sized opening accommodating an O-ring for sealing purposes and an annular retainer interposed between the outer diameter of the pipe end and the inner diameter of the coupling to mechanically hold the parts together. The retainer often has radially extending teeth which dig into the facing surfaces of the coupling and the pipe end to resist extraction of the pipe end from the coupling after engagement.

While these mechanical couplings avoid the above identified problems associated with soldered joints, they can suffer from one or more of the following disadvantages. To be effective, the retainer requires sufficient space within the coupling. Thus, the couplings tend to be oversized relatively to the pipes they are intended to receive, and if existing standard couplings are to be adapted for use with such a mechanical system, it is usually necessary to adapt a larger size standard fitting to a smaller size standard pipe. This is more expensive than adapting the standard fitting appropriate to the standard pipe in what is known as a “size-on-size” fitting. For example, a standard ¾ inch pipe fitting may be used to couple a ½ inch standard copper pipe in a mechanical system (not “size-on-size”). Furthermore, the retainer may not provide adequate pull-out strength, and the pipe end could be inadvertently separated from the coupling, for example, during a pressure spike within the pipe, caused by a sudden closing of a valve (the “water hammer effect”) which places the joint under increased tension.

The retainer also does not help keep the pipe end coaxial with the coupling upon insertion, allowing the pipe end to tip and deform the retainer and gouge the inside surface of the coupling or an elastomeric seal, such as an O-ring. In such a mechanical joint, there is furthermore little or no resistance to axial rotation of the pipe relatively to the coupling (i.e., relative rotation of the pipe and coupling about the longitudinal axis of the pipe). Thus, valves or other items mounted on the pipe will tend to rotate. Mechanical joints with retainers also tend to have little resistance to bending, allowing the pipe too much angular free play and permitting the pipe to “walk” out of the joint under repeated reversed bending loads. Excessive free play also tends to disengage the teeth on one side of the retainer and deform the teeth on the other side, weakening the joint. Furthermore, use of an enlarged section to accommodate the retainer may cause energy loss impeding fluid flow if the fluid is forced to flow into a coupling having a larger cross-sectional area. In general, when mechanical couplings are designed to overcome the aforementioned inherent disadvantages, they tend to suffer from a high part count, making them relatively complex and expensive.

There is clearly a need for a mechanical pipe coupling which avoids the disadvantages of both soldered pipe fittings, as well as prior art mechanical fittings described above, and which can be derived from existing standard fittings and used with pipes appropriate to the standard fitting in a “size-on-size” association rather than using a larger size fitting to couple smaller diameter pipes together.

### SUMMARY OF THE INVENTION

The invention concerns a pipe coupling housing having a socket with an inner diameter sized to receive a pipe and an outer diameter. The pipe coupling housing comprises an expanded region positioned adjacent to one end of the socket. The expanded region has an inner diameter and an outer diameter larger than the inner and outer diameters of the socket respectively. The expanded region also has an end defining an opening for receiving the pipe. A first shoulder is positioned between the socket and the expanded region. A second shoulder is positioned intermediate between the first shoulder and the opening. A third shoulder is positioned adjacent to the opening, and a lip is positioned at the opening in spaced relation to the third shoulder. The lip projects substantially radially inwardly. The functions of the various features of the housing are described below in the context of the pipe coupling.

The pipe coupling is sealingly engageable with a pipe. The pipe coupling comprises a housing as described above and further includes a sealing member positioned in the expanded region to effect a seal between the pipe coupling and the pipe. The sealing member engages the first shoulder which prevents the sealing member from moving further into the coupling housing when a pipe is received in the socket. A first support washer is positioned in the expanded region adjacent to the sealing member. The first support washer engages the second shoulder which acts as a stop preventing further motion of the first support washer toward the sealing member. A retainer is positioned within the expanded region adjacent to the first support washer. The retainer has a circumferential rim and a plurality of teeth projecting inwardly therefrom. A second support washer is positioned within the expanded region between the third shoulder and the opening. The second support washer engages the third shoulder and remains in spaced apart relation away from the first support washer over a distance at least equal to the width of the retainer rim. A lip is positioned at the opening in spaced relation to the third shoulder. The lip projects substantially radially inwardly to engage the second support washer and retain it between the third shoulder and the opening.

The invention also includes a method of manufacturing a pipe coupling housing. The method comprises the steps of:

(A) providing or forming a fitting having a socket;

(B) expanding a portion of the socket into an expanded region having a larger inner diameter than the socket, the first expanded region defining an opening;

(C) forming a first shoulder between the socket and the expanded region;

(D) forming a second shoulder between the first shoulder and the opening; and

(E) forming a third shoulder between the second shoulder and the opening.

The coupling may be assembled using the housing by inserting into the expanded region the sealing member, the retainer and the support washers and then forming the lip that captures these internal components within the expanded region.

Preferably, the fitting provided is one that is readily available and manufactured according to a standard, such as ASME Standard B16.22a-1998. This standard includes fittings having sockets sized to receive copper pipe having a nominal diameter between ½ inch and 2 inches inclusive. Other standards may also be considered, for example, standards wherein the socket is sized to receive copper pipe having a nominal diameter between 15 mm and 54 mm inclusive.

### BRIEF DESCRIPTION OF THE DRAWINGS

FIG. 1 is a partial longitudinal sectional view of a pipe coupling housing according to the invention;

FIG. 1A is a partial longitudinal sectional view of an alternate embodiment of a pipe coupling housing according to the invention;

FIG. 2 is a longitudinal sectional view of a pipe coupling according to the invention; and

FIG. 3 is an exploded perspective view of a pipe coupling in the form of an elbow fitting according to the invention.

### DETAILED DESCRIPTION OF THE PREFERRED EMBODIMENT

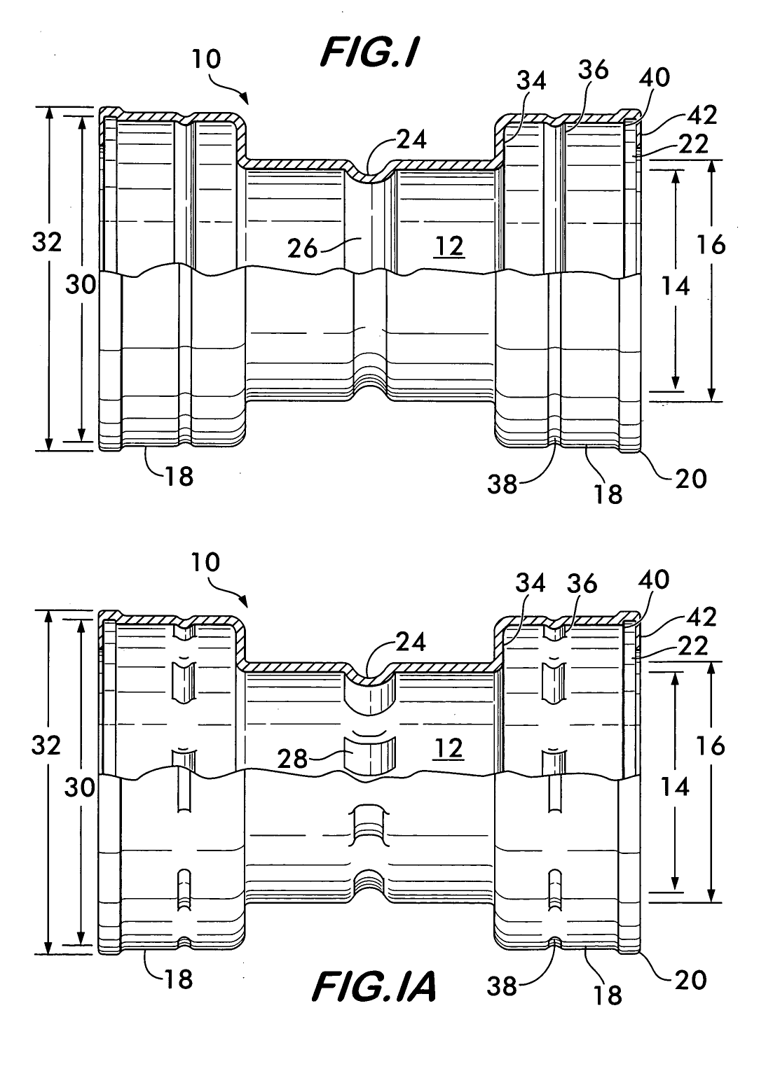

FIG. 1 shows a pipe coupling housing 10 according to the invention. Housing 10 is preferably formed from a readily available standard pipe fitting and has a socket 12 with an inner diameter 14 sized to receive a pipe. Socket 12 also has an outer diameter 16. An expanded region 18 is positioned adjacent to one end of the socket 12. The expanded region 18 has an end 20 opposite the socket 12 that defines an opening 22 for receiving the pipe. A pipe stop 24 is positioned adjacent to the opposite end of socket 12. Pipe stop 24 is formed by a surface 26 that projects substantially radially inwardly to engage the pipe received within the socket. The stop 24 may extend substantially continuously around the circumference of the housing as shown in FIG. 1, or it may comprise one or more discrete surfaces 28 as illustrated in FIG. 1A.

With reference again to FIG. 1, the expanded region 18 has an inner diameter 30 and an outer diameter 32 , both of which are larger, respectively, than the inner and outer diameters 14 and 16 of socket 12. A first shoulder 34 is positioned between the socket 12 and the expanded region 18. A second shoulder 36 is positioned within the expanded region 18 intermediate between the first shoulder 34 and the opening 22. Preferably, second shoulder 36 is formed by a dimple 38 projecting substantially radially inwardly of the housing 10. Dimple 38 may extend substantially continuously around the expanded region 18 or it may be discontinuous as shown in FIG. 1A. FIG. 1 shows a third shoulder 40 positioned adjacent to opening 22, and a lip 42, positioned at the opening 22 in spaced relation to the third shoulder. Lip 42 projects radially inwardly of the coupling 10. The functions of the various aforementioned features of the housing 10 are described below in the context of the pipe coupling and its components.

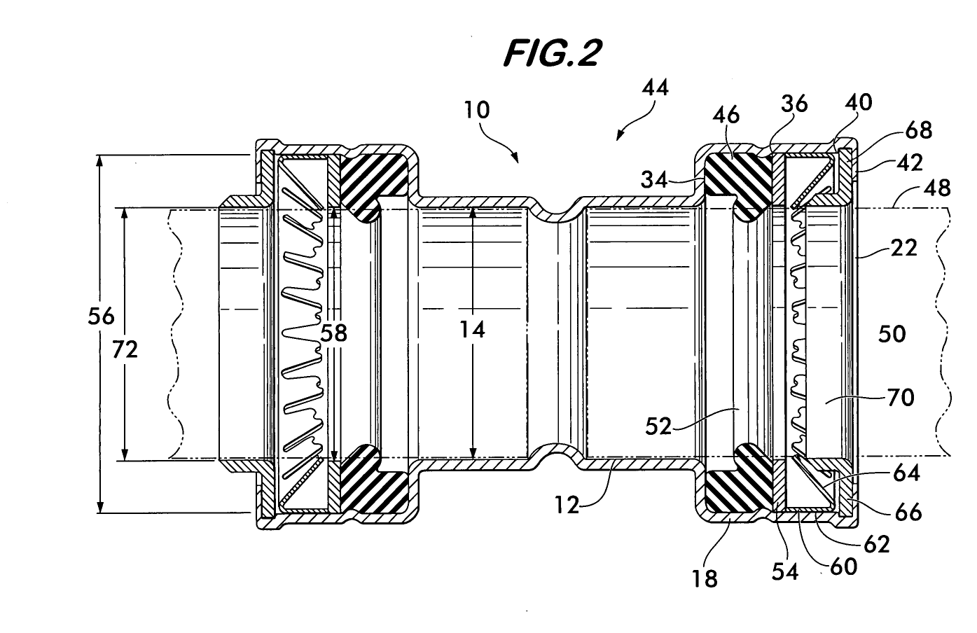

FIG. 2 is a longitudinal sectional view of a pipe coupling 44 according to the invention. Coupling 44 comprises housing 10 and further includes a sealing member 46 positioned within expanded region 18. Sealing member 46 engages first shoulder 34 and effects a seal between the outer surface 48 of a pipe 50 (shown in broken line received within the coupling) and the pipe coupling housing. Engagement between the sealing member 46 and the first shoulder 34 prevents the sealing member from being dislodged from the expanded region 18 upon insertion of pipe 50 into the socket 12. Preferably, sealing member 46 is a pressure responsive seal having a lobe or gland 52 that is pressurized by the fluid within the pipe 50, the pressure further forcing the gland 52 against the pipe outer surface 48 thereby effecting a fluid tight seal. Pressure responsive sealing members are advantageous because they provide a fluid tight seal without the need for significant interference between the sealing member 46 and the pipe 50, thus lowering the insertion force necessary to engage the pipe 50 with the coupling 44.

A first support washer 54 is positioned within the expanded region adjacent to the sealing member 46. First support washer 54 preferably engages or is engageable with the sealing member 46 to prevent its extrusion outwardly toward the opening 22 of coupling housing 10 when it is subjected to high fluid pressure within the pipe 50. The first support washer 54 has an outer diameter 56 that allows it to engage the second shoulder 36, thus fixing the washer's position within the expanded region 18. Preferably, the first support washer 54 also has an inner diameter 58 that is substantially equal to the socket inner diameter 14, allowing the first support washer to engage and support the pipe 50 received within the socket 12. Preferably, the first support washer is made from stainless steel to prevent corrosion although beryllium copper alloys, as well as high strength engineering plastics are also feasible. It is also feasible to attach seal 46 to support washer 54.

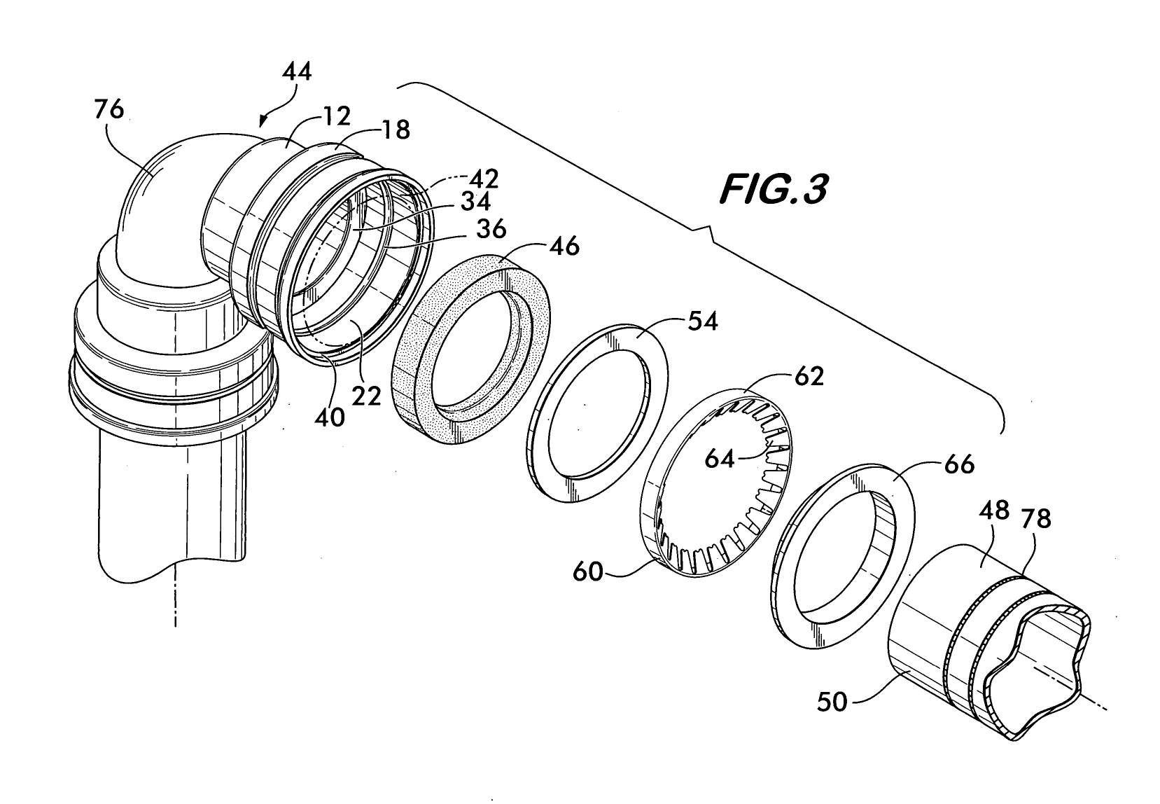

A retainer 60 is positioned within the expanded region 18 adjacent to the first support washer 54. Retainer 60 preferably comprises a circumferential rim 62 sized to fit substantially coaxially within the expanded region 18, and a plurality of teeth 64 projecting from the rim 62. Preferably, teeth 64 extend angularly inwardly toward the socket 12. The teeth 64 are designed to engage the outer surface 48 of pipe 50 when it is received within the housing 10. The angular orientation of the teeth 64 cause them to be “self jamming” in that they dig into the pipe surface 48 in response to outward motion (caused by internal pressure or external loads) to prevent withdrawal of the pipe from the coupling 44. This is particularly advantageous for plain end pipe as shown in FIG. 2. Engagement of the teeth 64 with the pipe 50 may be enhanced by the incorporation of circumferential grooves 78 around the pipe 50 as shown in FIG. 3. The grooves provide purchase for the teeth, increasing their ability to prevent withdrawal of the pipe from the coupling. Preferably, the retainer is made from stainless steel to prevent corrosion although beryllium copper alloys are also feasible. Engineering plastics are also feasible and may be used with plastic pipe and plastic fittings.

As shown in FIG. 2, a second support washer 66 is positioned within the expanded region 18. Second support washer 66 engages the third shoulder 40 which keeps the second support washer in spaced apart relation away from the first support washer 54 over a distance at least equal to the width of rim 62. It is found advantageous to maintain this separation between the support washers so as to avoid imposing contact forces between the second support washer 66 and the teeth 64 upon assembly of the coupling. Such contact forces operate to deflect the teeth 64 and relieve the preload between them and the pipe surface 48. Relief of the preload, if allowed to occur, inhibits the ability of the retainer to prevent withdrawal of the pipe 50 from the coupling 44, thus, reducing the maximum pressure at which the coupling maintains a fluid tight seal.

It is advantageous to construct the second support washer 66 from a circumferential flange 68 and a collar 70. Circumferential flange 68 is sized to engage the third shoulder 40 while the collar 70 is oriented transversely to the flange, preferably co-axially with the socket 12. Collar 70 preferably has an inner diameter 72 substantially equal to the inner diameter 14 of the socket 12 and can thereby provide alignment and support to the pipe 50 upon engagement with the coupling 44. As shown on the right side of FIG. 2, collar 70 may project inwardly to engage and support teeth 64 when they are deflected to the right by motion of pipe 50 to the right. Support of the teeth by the collar increases the force required to withdraw the pipe from the coupling, thus increasing the maximum pressure which the coupling can withstand. As shown on the left side of FIG. 2, collar 70 may also project outwardly from the coupling to increase the total distance over which pipe 50 is directly supported by the coupling 44, thus providing greater bending stiffness to the joint formed between the coupling and the pipe. Preferably, the second support washer is made from stainless steel to prevent corrosion although beryllium copper alloys, as well as high strength engineering plastics are also feasible.

Lip 42 surrounds and defines opening 22, the lip being positioned in spaced apart relation with the third shoulder 40 so that the second support washer 66 may be captured between the lip and the third shoulder. Lip 42 projects substantially radially inwardly to engage and capture the second support washer 66. Preferably lip 42 comprises a portion of expanded region 18 that is turned inwardly after the sealing member 46, first support washer 54, retainer 60 and second support washer 66 are positioned within the expanded region.

FIG. 3 shows an exploded view of a coupling 44 according to the invention in the form of an elbow fitting 76, it being understood that the coupling may take any of various practical forms including Tee fittings, reducers and may also be used on components such as valves, strainers and the like to couple the components to pipes as well as pipes to pipes. As described above, elbow fitting 76 is preferably formed from a standard fitting, for example ASME Standard B16.22a-1998. The expanded region 18 is adjacent to the socket 12, the first shoulder 34 is engaged by the sealing member 46, the first support washer 54 engages the second shoulder 36, the retainer 60 is positioned adjacent to the first support washer 54, the second support washer 66 engages the third shoulder 40 and is kept in spaced apart relation from the first support washer 54 over a distance at least equal to the width of the rim 62. Lip 42, shown in broken line, extends substantially radially inwardly to capture the aforementioned components within the expanded region 18. Lip 42 defines opening 22 that receives pipe 50, the pipe in this example having the aforementioned grooves 78 to provide purchase to teeth 64 of the retainer.

In manufacturing the coupling according to the invention, it is preferred to begin with a commonly available standard fitting such as those made according to ASME Standard B16.22a-1998 for wrought copper fittings. These fittings are especially appropriate for use to couple to pipes having a nominal diameter between ½ inch and 2 inches inclusive. Other standards are also available, for example British or German DIN standards that specify fittings appropriate for copper pipe having a nominal diameter between 15 mm and 54 mm inclusive. It is also feasible to form the fitting by various techniques. Cast and forged fittings are preferred for certain types of valves and other fittings, and such castings or forgings are compatible with the coupling housing design and internal components as described previously.

The method of manufacture according to the invention includes the steps of providing or forming the fitting, preferably a fitting manufactured to comply with a standard such as ASME Standard B 16.22a-1998, and then expanding a portion of the socket to form the expanded region. The expansion is preferably accomplished by die forming the existing fitting although other techniques, such as hydro-forming and spinning are also feasible.

The aforementioned die forming techniques may also be used to form the first shoulder between the socket and the expanded region as well as the second shoulder between the first shoulder and the opening and the third shoulder between the second shoulder and the opening. Once all of the shoulders have been formed the sealing member, the first support washer, the retainer and the second support washer are inserted into the expanded region and the lip is formed, preferably by rolling the free edge of the expanded region over so that the lip extends substantially radially inwardly of the coupling.

Couplings according to the invention provide a mechanical pipe coupling which can form a reliable fluid-tight joint without the hazards associated with brazing, welding or soldering while taking advantage of existing standard fittings in a size-on-size relationship with standard pipe to achieve significant economical advantage.

What is claimed is:

1. A pipe coupling housing having a socket with an inner diameter sized to receive a pipe and an outer diameter, said pipe coupling housing comprising:
an expanded region positioned adjacent to one end of said socket, said expanded region having an inner diameter and an outer diameter larger than said inner and outer diameters of said socket, said expanded region having an end defining an opening for receiving said pipe;
a first shoulder positioned between said socket and said expanded region;
a second shoulder positioned intermediate between said first shoulder and said opening;
a third shoulder positioned adjacent to said opening; and
a lip positioned at said opening in spaced relation to said third shoulder and projecting substantially radially inwardly.

2. A pipe coupling housing according to claim 1, wherein said lip extends substantially continuously around said open end.

3. A pipe coupling housing according to claim 1, wherein said second shoulder comprises a dimple positioned on said expanded region and projecting radially inwardly.

4. A pipe coupling housing according to claim 3, wherein said dimple extends substantially continuously around said expanded region.

5. A pipe coupling housing according to claim 1, further comprising a stop surface positioned adjacent to another end of said socket opposite said one end, said stop surface projecting radially inwardly and being engageable with said pipe end to prevent said pipe end from passing through said pipe coupling housing.

6. A pipe coupling housing according to claim 1, wherein said socket is sized to receive copper pipe having a nominal diameter between ½ inch and 2 inches inclusive.

7. A pipe coupling housing according to claim 1, wherein said socket is sized to receive copper pipe having a diameter between 15 mm and 54 mm inclusive.

8. A pipe coupling housing according to claim 1, wherein said coupling housing comprises an elbow fitting.

9. A pipe coupling housing according to claim 1, wherein said coupling housing comprises a straight fitting.

10. A pipe coupling sealingly engageable with a pipe, said pipe coupling comprising:
a coupling housing having a socket with an inner diameter sized to receive said pipe;
an expanded region positioned adjacent to one end of said socket, said expanded region having an inner diameter larger than said inner diameter of said socket, said expanded region having an end defining an opening for receiving said pipe;
a first shoulder positioned between said socket and said expanded region;
a sealing member positioned in said expanded region to effect a seal between said pipe coupling and said pipe, said sealing member engaging said first shoulder;
a second shoulder positioned intermediate between said first shoulder and said opening;
a first support washer positioned in said expanded region adjacent to said sealing member, said first support washer engaging said second shoulder;
a retainer positioned within said expanded region adjacent to said first support washer, said retainer having a circumferential rim having a width and a plurality of teeth projecting inwardly therefrom;
a third shoulder positioned between said second shoulder and said opening;
a second support washer positioned within said expanded region between said third shoulder and said opening, said second support washer being in spaced apart relation away from said first support washer over a distance at least equal to said width of said circumferential rim; and
a lip positioned at said opening in spaced relation to said third shoulder, said lip projecting substantially radially inwardly engaging said second support washer to retain it between said third shoulder and said opening.

11. A pipe coupling according to claim 10, wherein said housing further comprises an outer diameter larger than said outer diameter of said socket.

12. A pipe coupling according to claim 10, wherein said lip extends substantially continuously around said open end.

13. A pipe coupling according to claim 10, wherein said second shoulder comprises a dimple positioned on said expanded region and projecting radially inwardly.

14. A pipe coupling according to claim 10, wherein said first support washer has an inner diameter substantially equal to said inner diameter of said socket.

15. A pipe coupling according to claim 10, wherein said second support washer comprises a circumferential flange and a circumferential collar oriented transversely to said flange, said flange being captured between said lip and said third shoulder, said collar having an inner diameter substantially equal to said inner diameter of said socket.

16. A pipe coupling according to claim 15, wherein said collar projects outwardly from said open end of said coupling housing.

17. A pipe coupling according to claim 15, wherein said collar projects into said expanded region, said collar being engageable with said teeth to provide support thereto.

18. A pipe coupling according to claim 10, wherein said socket is sized to receive copper pipe having a nominal diameter between ½ inch and 2 inches inclusive.

19. A pipe coupling according to claim 10, wherein said socket is sized to receive copper pipe having a nominal diameter between 15 mm and 54 mm inclusive.

20. A pipe coupling according to claim 10, wherein said coupling comprises an elbow fitting.

21. A pipe coupling according to claim 10, wherein said coupling comprises a straight fitting.

22. A pipe coupling according to claim 10, wherein said sealing member comprises a pressure responsive seal.

23. A method of manufacturing a pipe coupling housing, said method comprising the steps of:
providing a fitting having a socket;
expanding a portion of said socket into an expanded region having a larger inner diameter than said socket, said first expanded region defining an opening;
forming a first shoulder between said socket and said expanded region;
forming a second shoulder between said first shoulder and said opening; and
forming a third shoulder between said second shoulder and said opening.

24. A method according to claim 23, further comprising the steps of inserting into said expanded region a sealing means, a first support washer, a retainer and a second support washer.

25. A method according to claim 24, further comprising the step of forming a lip at an end of said expanded region.

26. A method according to claim 23, wherein said fitting comprises a fitting manufactured according to a standard.

27. A method according to claim 26, wherein said socket is sized to receive copper pipe having a nominal diameter between ½ inch and 2 inches inclusive.

28. A method according to claim 26, wherein said socket is sized to receive copper pipe having a nominal diameter between 15 mm and 54 mm inclusive.

29. A method according to claim 26, wherein said standard is ASME Standard B16.22a-1998.

30. A method of manufacturing a pipe coupling housing, said method comprising the steps of:
forming a fitting having a socket;
expanding a portion of said socket into an expanded region having a larger inner diameter than said socket, said first expanded region defining an opening;
forming a first shoulder between said socket and said expanded region;
forming a second shoulder between said first shoulder and said opening; and
forming a third shoulder between said second shoulder and said opening.
